(19) United States
(12) Patent Application Publication
(10) Pub. No.: US 2025/0357486 A1
(43) Pub. Date: Nov. 20, 2025

(54) NEGATIVE ELECTRODE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Jin Seok PARK, Yongin-si (KR); HYUN NAM, Yongin-si (KR); Taeil LEE, Yongin-si (KR); JeongJoo PARK, Yongin-si (KR); Minho LEE, Yongin-si (KR); Yunshik CHO, Yongin-si (KR); Kyunghwa JUNG, Yongin-si (KR)

(73) Assignee: SAMSUNG SDI CO., LTD., Yongin-si (KR)

(21) Appl. No.: 19/024,629

(22) Filed: Jan. 16, 2025

(30) Foreign Application Priority Data
May 14, 2024 (KR) 10-2024-0063446

(51) Int. Cl. H01M 4/62; H01M 4/02; H01M 4/36; H01M 4/38; H01M 10/052

(52) U.S. Cl. CPC H01M 4/621; H01M 4/366; H01M 4/386; H01M 10/052; H01M 2004/027

(57) ABSTRACT

Disclosed are negative electrodes and rechargeable lithium batteries. The negative electrode includes a negative electrode current collector, and a negative electrode active material layer on the negative electrode current collector. The negative electrode active material layer includes a first active material layer, a second active material layer, and a third active material layer that are stacked on the negative electrode current collector. The second active material layer includes a silicon-containing particle and a high-strength binder. The high-strength binder includes a unit derived from a first monomer, and a unit derived from a second monomer. The first monomer includes one or more of a (meth)allyl ether monomer and a (meth)acrylic ester monomer. The second monomer includes a (meth)acrylic monomer.

### CROSS-REFERENCE TO RELATED APPLICATION

This U.S. nonprovisional application claims priority under 35 U.S.C § 119 to Korean Patent Application No. 10-2024-0063446 filed on May 14, 2024 in the Korean Intellectual Property Office, the disclosure of which is hereby incorporated by reference in its entirety.

### BACKGROUND

The present disclosure relates to a negative electrode for a rechargeable lithium battery, to a rechargeable lithium battery including the negative electrode, and more particularly, to a multilayered negative electrode for a rechargeable lithium battery, and to a rechargeable lithium battery including the multilayered negative electrode.

Recently, with the rapid spread of battery using electronic devices, such as, e.g., mobile phones, laptop computers, electric vehicles, and the like, there is a rapidly increasing demand for rechargeable batteries with high energy density and high capacity.

A rechargeable lithium battery typically includes a positive electrode, a negative electrode, and an electrolyte, the positive and negative electrodes include an active material in which intercalation and deintercalation are possible, and generates electrical energy caused by oxidation and reduction reactions when lithium ions are intercalated and deintercalated.

### SUMMARY

An example embodiment of the present disclosure provides a negative electrode for a rechargeable lithium battery having desired or improved lifetime characteristics.

An example embodiment of the present disclosure provides a rechargeable lithium battery having desired or improved lifetime characteristics.

According to an example embodiment of the present disclosure, a negative electrode for a rechargeable lithium battery may include a negative electrode current collector, and a negative electrode active material layer on the negative electrode current collector. The negative electrode active material layer may include a first active material layer, a second active material layer, and a third active material layer that are stacked, e.g., sequentially stacked, on the negative electrode current collector. The second active material layer may include a silicon-containing particle and a high-strength binder. The high-strength binder may include a unit derived from a first monomer; and a unit derived from a second monomer. The first monomer may include one or more of a (meth)allyl ether monomer and a (meth)acrylic ester monomer. The second monomer may be or include a (meth)acrylic monomer.

According to an example embodiment of the present disclosure, a negative electrode for a rechargeable lithium battery may include a negative electrode current collector, and a negative electrode active material layer on the negative electrode current collector. The negative electrode active material layer may include at least one of crystalline carbon, a silicon-containing particle, and a high-strength binder. The negative electrode active material layer may have a first region adjacent to the negative electrode current collector, a third region adjacent to a top surface of the negative electrode active material layer, and a second region on a center of the negative electrode active material layer. The second region may be interposed, e.g., vertically interposed, between the first region and the third region. An amount of the silicon-containing particle in the second region may be greater than an amount of the silicon-containing particle in the first region. The amount of the silicon-containing particle in the second region may be greater than an amount of the silicon-containing particle in the third region. An amount of the high-strength binder in the second region may be greater than an amount of the high-strength binder in the first region. The amount of the high-strength binder in the second region may be greater than an amount of the high-strength binder in the third region.

According to an example embodiment of the present disclosure, a rechargeable lithium battery may include the negative electrode, a positive electrode that includes a positive electrode current collector and a positive electrode active material layer on the positive electrode current collector, and a separator between the negative electrode and the positive electrode.

### BRIEF DESCRIPTION OF DRAWINGS

FIG. 1 illustrates a simplified conceptual diagram showing a rechargeable lithium battery according to an example embodiment of the present disclosure.

FIGS. 2 to 5 illustrate simplified diagrams showing a rechargeable lithium battery according to an example embodiment of the present disclosure.

FIG. 6 illustrates a cross-sectional view showing a rechargeable lithium battery according to an example embodiment of the present disclosure.

FIG. 7 illustrates an enlarged view showing a negative electrode for a rechargeable lithium battery according to an example embodiment of the present disclosure.

FIG. 8 illustrates a cross-sectional view showing a method of manufacturing a negative electrode according to an example embodiment of the present disclosure.

### DETAILED DESCRIPTION

In order to sufficiently understand the configuration and effect of the present disclosure, some example embodiments of the present disclosure will be described with reference to the accompanying drawings. It should be noted, however, that the present disclosure is not limited to the following example embodiments, and may be implemented in various forms. Rather, the example embodiments are provided only to disclose the present disclosure and let those skilled in the art fully know the scope of the present disclosure.

In this description, it will be understood that, when an element is referred to as being “on” another element, the element can be directly on the other element, or intervening elements may be present between therebetween. In the drawings, thicknesses of some components may be exaggerated for effectively explaining the technical contents. Like reference numerals refer to like elements throughout the specification.

Unless otherwise specially noted in this description, the expression of singular form may include the expression of plural form. In addition, unless otherwise specially noted, the phrase “A or B” may indicate “A but not B,” “B but not A,” and “A and B.” The terms “comprises/includes” and/or “comprising/including” used in this description do not exclude the presence or addition of one or more other components.

As used herein, the term “combination thereof” may refer to a mixture, a stack, a composite, a copolymer, an alloy, a blend, or a reaction product.

Unless otherwise especially defined in this description, a particle diameter may be an average particle diameter. In addition, a particle diameter indicates an average particle diameter (D₅₀) where a cumulative volume is about 50 volume % in a particle size distribution. The average particle diameter (D₅₀) may be measured by a method widely known to those skilled in the art, for example, by a particle size analyzer, a transmission electron microscope (TEM) image, or a scanning electron microscope (SEM) image. Alternatively, a dynamic light-scattering measurement device is used to perform a data analysis, the number of particles is counted for each particle size range, and from this, an average particle diameter (D₅₀) value may be obtained through a calculation. Dissimilarly, a laser scattering method may be utilized to measure the average particle diameter (D₅₀). In the laser scattering method, a target particle is distributed in a dispersion solvent, introduced into a laser scattering particle measurement device (e.g., MT3000 commercially available from Microtrac, Inc), irradiated with ultrasonic waves of 28 kHz at a power of 60 W, and an average particle diameter (D₅₀) is then calculated in the 50% standard of particle diameter distribution in the measurement device.

In this disclosure, the term “substituted or unsubstituted” may refer to substituted or unsubstituted with at least one substituent that includes at least one of a deuterium atom, a halogen atom, a cyano group, a nitro group, an amine group, a silyl group, an oxy group, a thio group, a sulfinyl group, a sulfonyl group, a carbonyl group, a boron group, a phosphine oxide group, a phosphine sulfide group, an alkyl group, an alkenyl group, an alkoxy group, a hydrocarbon ring group, an aryl group, and a heterocyclic group. In addition, each substituent mentioned above may be substituted or unsubstituted. For example, a biphenyl group may be interpreted as an aryl group or as a phenyl group substituted with a phenyl group.

In this description, the halogen atom may include at least one of fluorine, chlorine, bromine, and iodine atoms.

In this disclosure, an alkyl group may be linear or branched. The number of carbon atoms in the alkyl group may range from 1 to 50, from 1 to 30, from 1 to 10, or from 1 to 6. The alkyl group may include, for example, at least one of a methyl group, an ethyl group, an n-propyl group, an isopropyl group, an n-butyl group, an s-butyl group, a t-butyl group, an i-butyl group, a 2-ethylbutyl group, a 3,3-dimethylbutyl group, an n-pentyl group, an i-pentyl group, a neopentyl group, a t-pentyl group, a cyclopentyl group, a 1-methylpentyl group, a 3-methylpentyl group, a 2-ethylpentyl group, a 4-methyl-2-pentyl group, an n-hexyl group, a 1-methylhexyl group, a 2-ethylhexyl group, a 2-butylhexyl group, a cyclohexyl group, a 4-methylcyclohexyl group, a 4-t-butylcyclohexyl group, an n-heptyl group, a 1-methylheptyl group, a 2,2-dimethylheptyl group, a 2-ethylheptyl group, a 2-butylheptyl group, an n-octyl group, t-octyl group, a 2-ethyloctyl group, a 2-butyloctyl group, a 2-hexyloctyl group, a 3,7-dimethyloctyl group, a cyclooctyl group, an n-nonyl group, an n-decyl group, an adamantyl group, a 2-ethyldecyl group, a 2-butyldecyl group, a 2-hexyldecyl group, a 2-octyldecyl group, an n-undecyl group, an n-dodecyl group, a 2-ethyldodecyl group, a 2-butyldodecyl group, a 2-hexyldocecyl group, a 2-octyldodecyl group, an n-tridecyl group, an n-tetradecyl group, an n-pentadecyl group, an n-hexadecyl group, a 2-ethylhexadecyl group, a 2-butylhexadecyl group, a 2-hexylhexadecyl group, a 2-octylhexadecyl group, an n-heptadecyl group, an n-octadecyl group, an n-nonadecyl group, an n-eicosyl group, a 2-ethyleicosyl group, a 2-butyleicosyl group, a 2-hexyleicosyl group, a 2-octyleicosyl group, an n-henicosyl group, an n-docosyl group, an n-tricosyl group, an n-tetracosyl group, an n-pentacosyl group, an n-hexacosyl group, an n-heptacosyl group, an n-octacosyl group, an n-nonacosyl group, or an n-triacontyl group, but the present disclosure is not limited thereto.

In this disclosure, the alkenyl group may refer to a hydrocarbon group containing one or more carbon double bonds in the middle or at the end of an alkyl group with two or more carbon atoms. The alkenyl group may be linear or branched. The number of carbon atoms is not particularly limited, but may range from 2 to 30, from 2 to 20, or from 2 to 10. The alkenyl group may be or include, for example, at least one of a vinyl group, a 1-butenyl group, a 1-pentenyl group, a 1,3-butadienyl group, a styrenyl group, or a styrylvinyl group, but the present disclosure is not limited thereto.

In this disclosure, the alkynyl group may refer to a hydrocarbon group containing one or more carbon triple bonds in the middle or at the end of an alkyl group with two or more carbon atoms. The alkynyl group may be linear or branched. The number of carbon atoms is not particularly limited, but may range from 2 to 30, from 2 to 20, or from 2 to 10. The alkynyl group may be or include, for example, an ethynyl group or a propynyl group, but the present disclosure is not limited thereto.

When the terms “about” or “substantially” are used in this specification in connection with a numerical value, it is intended that the associated numerical value include a tolerance of +10% around the stated numerical value. When ranges are specified, the range includes all values therebetween such as increments of 0.1%.

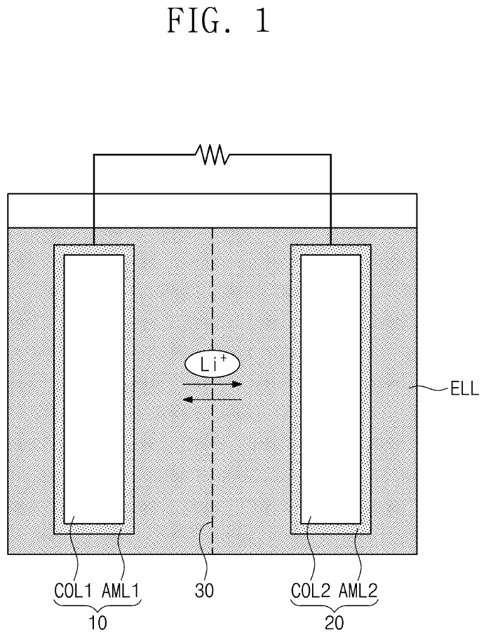

FIG. 1 illustrates a simplified conceptual diagram showing a rechargeable lithium battery according to an example embodiment of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced apart from each other across the separator 30. The separator 30 may be disposed between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated in the electrolyte ELL.

The electrolyte ELL may be or include a medium by which lithium ions are transferred between the positive electrode 10 and the negative electrode 20. In the electrolyte ELL, the lithium ions may move through the separator 30 toward one of the positive electrode 10 and the negative electrode 20.

### Positive Electrode 10

The positive electrode 10 for a rechargeable lithium battery may include a current collector COL1 and a positive electrode active material layer AML1 formed on the current collector COL1. The positive electrode active material layer AML1 may include a positive electrode active material and may further include a binder and/or a conductive material.

For example, the positive electrode 10 may further include an additive that can be or constitute a sacrificial positive electrode.

An amount of the positive electrode active material may be about 90 wt % to about 99.5 wt % relative to 100 wt % of the positive electrode active material layer AML1. An amount of each of the binder and the conductive material may be about 0.5 wt % to about 5 wt % relative to 100 wt % of the positive electrode active material layer AML1.

The binder may be configured to improve attachment of positive electrode active material particles to each other, and also to improve attachment of the positive electrode active material to the current collector COL1. The binder may include, for example, at least one of polyvinyl alcohol, carboxymethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, or nylon, but the present disclosure is not limited thereto.

The conductive material may provide an electrode with conductivity, and any suitable conductive material that does not cause a chemical change in a battery may be or constitute the conductive material. The conductive material may include, for example, a carbon-based material such as at least one of natural graphite, artificial graphite, carbon black, acetylene black, Ketjen black, carbon fiber, carbon nano-fiber, and carbon nano-tube; a metal powder or metal fiber containing one or more of copper, nickel, aluminum, and silver; a conductive polymer such as a polyphenylene derivative; or a mixture thereof.

Aluminum (Al) may be or constitute the current collector COL1, but the present disclosure is not limited thereto.

### Positive Electrode Active Material

The positive electrode active material in the positive electrode active material layer AML1 may include a compound (e.g., lithiated intercalation compound) that can reversibly intercalate and deintercalate lithium. For example, the positive electrode active material may include at least one kind of composite oxide including lithium and metal that is or includes at least one of cobalt, manganese, nickel, and a combination thereof.

The composite oxide may include lithium transition metal composite oxide, for example, at least one of lithium-nickel-based oxide, lithium-cobalt-based oxide, lithium-manganese-based oxide, lithium-iron-phosphate-based compounds, cobalt-free nickel-manganese-based oxide, or a combination thereof.

For example, the positive electrode active material may include a compound expressed by at least one of chemical formulae below. LiₐA_{1-b}X_{b}O_{2-c}D_{c} (where 0.90≤a≤1.8, 0≤b≤0.5, and 0≤c≤0.05); LiₐMn_{2-b}X_{b}O_{4-c}D_{c} (where 0.90≤a≤1.8, 0≤b≤0.5, and 0≤c≤0.05); LiₐNi_{1-b-c}Co_{b}X_{c}O_{2-α}D_{α} (where 0.90≤a≤1.8, 0≤b≤0.5, 0≤c≤0.5, and 0<α<0.5); LiₐNi_{1-b-c}Mn_{b}X_{c}O_{2-α}D_{α} (where 0.90≤a≤1.8, 0≤b≤0.5, 0≤c≤0.5, and 0<α<2); LiₐNi_{b}Co_{c}L¹_{d}GₑO₂ (where 0.90≤a≤1.8, 0≤b≤0.9, 0≤c≤0.5, 0≤d≤0.5, and 0≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMn_{1-b}G_{b}O₂ (where 0.90≤a≤1.8 and 0.001≤b≤0.1); LiₐMn₂G_{b}O₄ (where 0.90≤a≤1.8 and 0.001≤b≤0.1); LiₐMn_{1-g}G_{g}PO₄ (where 0.90≤a≤1.8 and 0≤g≤0.5); Li_{(3-f)}Fe₂(PO₄)₃ (where 0≤f≤2); LiₐFePO₄ (where 0.90≤a≤1.8).

In the chemical formulae above, A is or includes at least one of Ni, Co, Mn, or a combination thereof, X is or includes at least one of Al, Ni, Co, Mn, Cr, Fe, Mg, Sr, V, a rare-earth element, or a combination thereof, D is or includes at least one of O, F, S, P, or a combination thereof, G is or includes at least one of Al, Cr, Mn, Fe, Mg, La, Ce, Sr, V, or a combination thereof, and L¹ is or includes at least one of Mn, Al, or a combination thereof.

For example, the positive electrode active material may be or include a high-nickel-based positive electrode active material having a nickel amount that is equal to or greater than about 80 mol %, equal to or greater than about 85 mol %, equal to or greater than about 90 mol %, equal to or greater than about 91 mol %, or equal to or greater than about 94 mol % and equal to or less than about 99 mol % relative to 100 mol % of metal devoid of lithium in the lithium transition metal composite oxide. The above-discussed high-nickel-based positive electrode active material may achieve high capacity and thus may be applied to a high-capacity and high-density rechargeable lithium battery.

### Negative Electrode 20

The negative electrode 20 for a rechargeable lithium battery may include a current collector COL2 and a negative electrode active material layer AML2 positioned on the current collector COL2. The negative electrode active material layer AML2 may include a negative electrode active material, and may further include a binder and/or a conductive material.

For example, the negative electrode active material layer AML2 may include a negative electrode active material of about 90 wt % to about 99 wt %, a binder of about 0.5 wt % to about 5 wt %, and a conductive material of about 0 wt % to about 5 wt %.

The binder may be configured to improve attachment of negative electrode active material particles to each other, and also to improve attachment of the negative electrode active material to the current collector COL2. The binder may include a non-aqueous binder, an aqueous binder, a dry binder, or a combination thereof.

The non-aqueous binder may include at least one of polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamide imide, polyimide, or a combination thereof.

The aqueous binder may include styrene-butadiene rubber, (meth)acrylated styrene-butadiene rubber, (meth)acrylonitrile-butadiene rubber, (meth)acrylic rubber, butyl rubber, fluoro elastomer, polyethylene oxide, polyvinyl pyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, polyvinyl alcohol, or a combination thereof.

When an aqueous binder is the negative electrode binder, a cellulose-based compound capable of providing viscosity may further be included. A cellulose-based compound may be the thickener. The cellulose-based compound may include one or more of carboxymethyl cellulose, hydroxypropylmethyl cellulose, methyl cellulose, and alkali metal salts thereof. The alkali metal may include at least one of Na, K, or Li.

The dry binder may include a fibrillizable polymer material, for example, at least one of polytetrafluoroethylene, polyvinylidene fluoride, polyvinylidene fluoride-hexafluoropropylene copolymer, polyethylene oxide, or a combination thereof.

The conductive material may be configured to provide an electrode with conductivity, and any suitable conductive material that does not cause a chemical change in a battery may be or constitute the conductive material. For example, the conductive material may include a carbon-based material such as at or including least one of natural graphite, artificial graphite, carbon black, acetylene black, Ketjen black, carbon fiber, carbon nano-fiber, and carbon nano-tube; a metal powder or metal fiber including one or more of copper, nickel, aluminum, and silver; a conductive polymer such as a polyphenylene derivative; or a mixture thereof.

The current collector COL2 may include at least one of a copper foil, a nickel foil, a stainless-steel foil, a titanium foil, a nickel foam, a copper foam, a polymer substrate coated with a conductive metal, or a combination thereof.

### Negative Electrode Active Material

The negative electrode active material in the negative electrode active material layer AML2 may include a material that can reversibly intercalate and deintercalate lithium ions, lithium metal, a lithium metal alloy, a material that can dope and de-dope lithium, or transition metal oxide.

The material that can reversibly intercalate and deintercalate lithium ions may include a carbon-based negative electrode active material, for example, crystalline carbon, amorphous carbon, or a combination thereof. For example, the crystalline carbon may include graphite such as non-shaped, sheet-shaped, flake-shaped, sphere-shaped, or fiber-shaped natural or artificial graphite, and the amorphous carbon may include at least one of soft carbon, hard carbon, mesophase pitch carbon, or calcined coke.

The lithium metal alloy may include an alloy of lithium and metal that is or includes at least one of Na, K, Rb, Cs, Fr, Be, Mg, Ca, Sr, Si, Sb, Pb, In, Zn, Ba, Ra, Ge, Al, and Sn.

The material that can dope and de-dope lithium may include a Si-based negative electrode active material or a Sn-based negative electrode active material. The Si-based negative electrode active material may include at least one of silicon, silicon-carbon composite, SiOx (where 0<x<2), Si-Q alloy (where Q is alkali metal, alkaline earth metal, Group 13 element, Group 14 element (except for Si), Group 15 element, Group 16 element, transition metal, a rare-earth element, or a combination thereof), or a combination thereof. The Sn-based negative electrode active material may include at least one of Sn, SnO₂, a Sn-based alloy, a combination thereof.

The silicon-carbon composite may be or include a composite of silicon and amorphous carbon. According to an example embodiment, the silicon-carbon composite may have a structure in which the amorphous carbon is coated on a surface of the silicon particle. For example, the silicon-carbon composite may include a secondary particle (core) in which primary silicon particles are assembled, and an amorphous carbon coating layer (shell) positioned on a surface of the secondary particle. The amorphous carbon may also be positioned between the primary silicon particles, and for example, the primary silicon particles may be coated with the amorphous carbon. The secondary particles may be dispersed in an amorphous carbon matrix.

The silicon-carbon composite may further include crystalline carbon. For example, the silicon-carbon composite may include a core including crystalline carbon and silicon particles, and may also include an amorphous carbon coating layer positioned on a surface of the core.

The Si-based negative electrode active material or the Sn-based negative electrode active material may be combined with a carbon-based negative electrode active material.

### Separator 30

Based on type of the rechargeable lithium battery, the separator 30 may be present between positive electrode 10 and the negative electrode 20. The separator 30 may include one or more of polyethylene, polypropylene, and polyvinylidene fluoride, and may have a multi-layered separator thereof such as or including at least one of a polyethylene/polypropylene bi-layered separator, a polyethylene/polypropylene/polyethylene tri-layered separator, and a polypropylene/polyethylene/polypropylene tri-layered separator.

The separator 30 may include a porous substrate and a coating layer positioned on one or on opposite surfaces of the porous substrate, the coating layer including an organic material, an inorganic material, or a combination thereof.

The porous substrate may be or include a polymer layer including at least one of polyolefin such as polyethylene and polypropylene, polyester such as polyethylene terephthalate and polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, cyclic olefin copolymer, polyphenylenesulphide, polyethylene naphthalate, glass fiber, Teflon, and polytetrafluoroethylene, or may be or include a copolymer or mixture including two or more of the materials mentioned above.

The organic material may include a polyvinylidenefluoride-based copolymer or a (meth)acrylic copolymer.

The inorganic material may include an inorganic particle including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, or a combination thereof, but the present disclosure is not limited thereto.

The organic material and the inorganic material may be mixed in one coating layer, or may be present as a stack of a coating layer including the organic material, and a coating layer including an inorganic material.

### Electrolyte ELL

The electrolyte ELL for the rechargeable lithium battery may include a non-aqueous organic solvent and a lithium salt.

The non-aqueous organic solvent may be or constitute a medium for transmitting ions that participate in an electrochemical reaction of the battery.

The non-aqueous organic solvent may include at least one of a carbonate-based solvent, an ester-based solvent, an ether-based solvent, a ketone-based solvent, an alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), or butylene carbonate (BC).

The ester-based solvent may include at least one of methyl acetate, ethyl acetate, n-propyl acetate, dimethyl acetate, methyl propionate, ethyl propionate, decanolide, mevalonolactone, valerolactone, or caprolactone.

The ether-based solvent may include at least one of dibutyl ether, tetraglyme, diglyme, dimethoxyethane, 2-methyltetrahydrofuran, 2.5-dimethyltetrahydrofuran, or tetrahydrofuran. The ketone-based solvent may include cyclohexanone. The alcohol-based solvent may include ethyl alcohol or isopropyl alcohol. The aprotic solvent may include at least one of nitriles such as R—CN (where R is a hydrocarbon group having a C2 to C20 linear, branched, or cyclic structure and may include a double bond, an aromatic ring, or an ether group), amides such as dimethylformamide, dioxolanes such as 1,3-dioxolane or 1.4-dioxolane, or sulfolanes.

The non-aqueous organic solvent may be used alone or in a mixture of two or more substances.

In addition, when a carbonate-based solvent is used, a cyclic carbonate and a chain carbonate may be mixed and used, and the cyclic carbonate and the chain carbonate may be mixed in a volume ratio of about 1:1 to about 1:9.

The lithium salt may be or include a material that is dissolved in the non-aqueous organic solvent to be or constitute a supply source of lithium ions in a battery and plays a role in enabling a basic operation of a rechargeable lithium battery and in promoting the movement of lithium ions between positive and negative electrodes. The lithium salt may include, for example, at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (where x and y are integers between 1 and 20), lithium trifluoromethane sulfonate, lithium tetrafluoroethanesulfonate, lithium difluorobis(oxalato)phosphate (LiDFBOP), and lithium bis(oxalato) borate (LiBOB)

### Rechargeable Lithium Battery

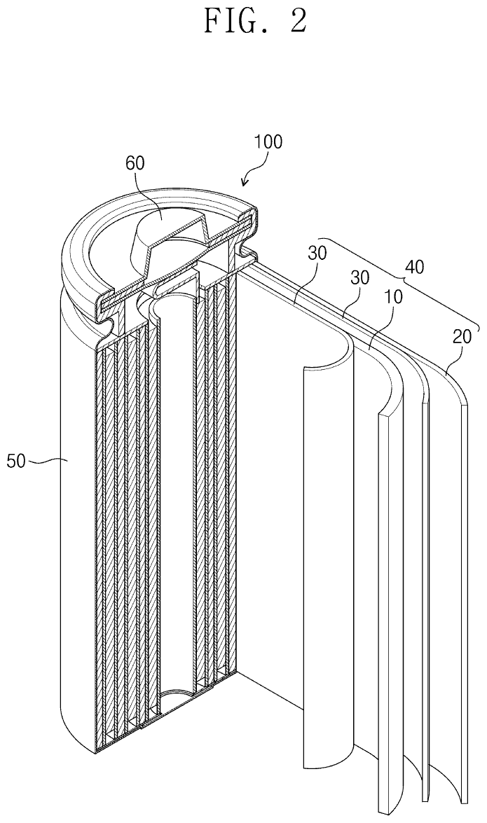

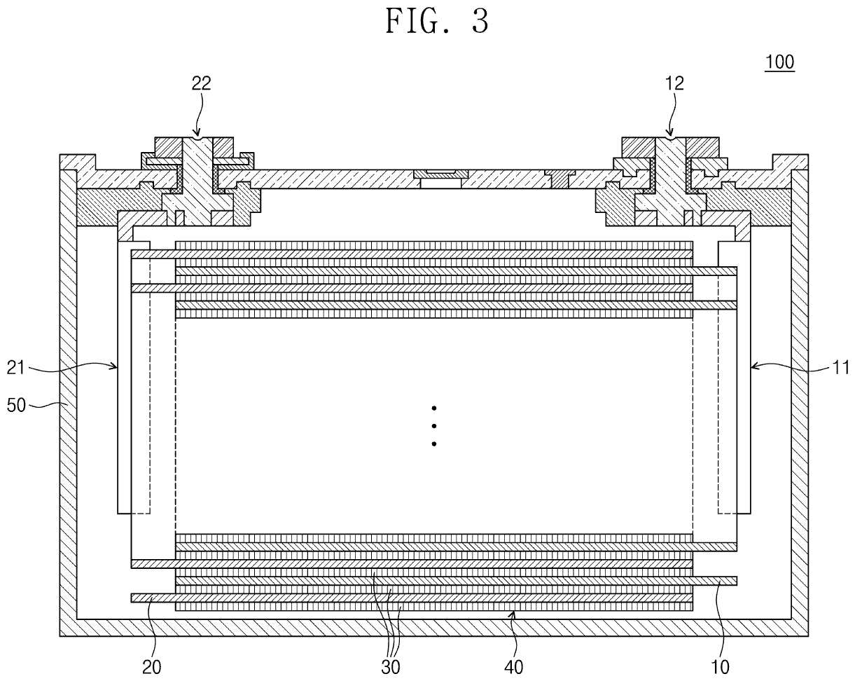

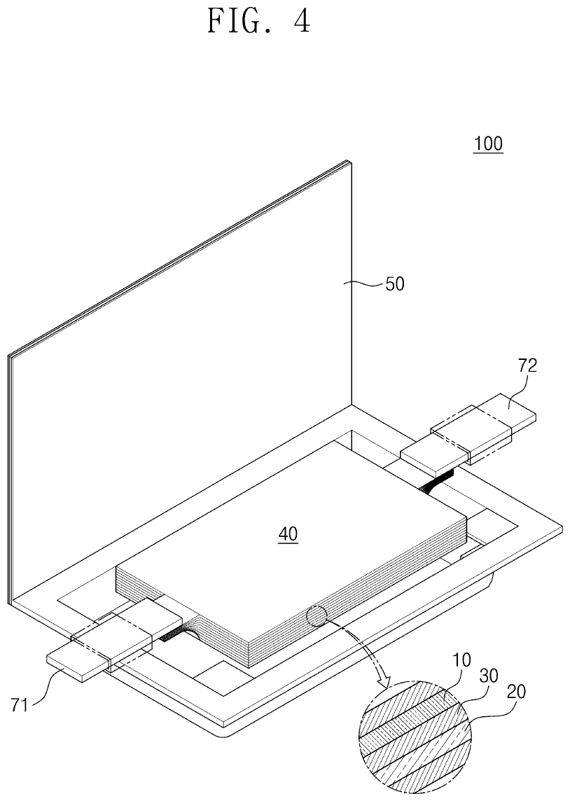

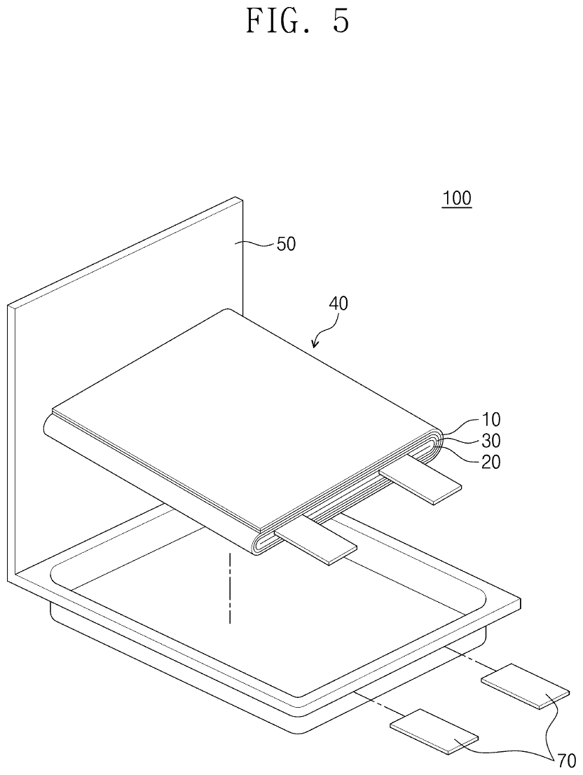

Based on the shape of a rechargeable lithium battery, the rechargeable lithium battery may be classified into, e.g., cylindrical, prismatic, pouch, and coin types. FIGS. 2 to 5 illustrate simplified diagrams illustrating a rechargeable lithium battery according to an example embodiment, with FIG. 2 showing a cylindrical battery, FIG. 3 illustrating a prismatic battery, and FIGS. 4 and 5 illustrating pouch-type batteries. Referring to FIGS. 2 to 5, a rechargeable lithium battery 100 may include an electrode assembly 40 in which a separator 30 is interposed between a positive electrode 10 and a negative electrode 20, and may also include a casing 50 in which the electrode assembly 40 is accommodated. The positive electrode 10, the negative electrode 20, and the separator 30 may be impregnated in an electrolyte (not shown). The rechargeable lithium battery 100 may include a sealing member 60 that seals the casing 50, as illustrated in FIG. 2. In addition, as illustrated in FIG. 3, the rechargeable lithium battery 100 may include a positive electrode lead tab 11, a positive electrode terminal 12, a negative electrode lead tab 21, and a negative electrode terminal 22. As shown in FIGS. 4 and 5, the rechargeable lithium battery 100 may include an electrode tab 70 illustrated in FIG. 5, or a positive electrode tab 71 and a negative electrode tab 72 illustrated in FIG. 4, the electrode tabs 70/71/72 forming an electrical path for externally inducing a current generated in the electrode assembly 40 to outside of the battery 100.

The following description will focus on a rechargeable lithium battery according to some example embodiments of the present disclosure.

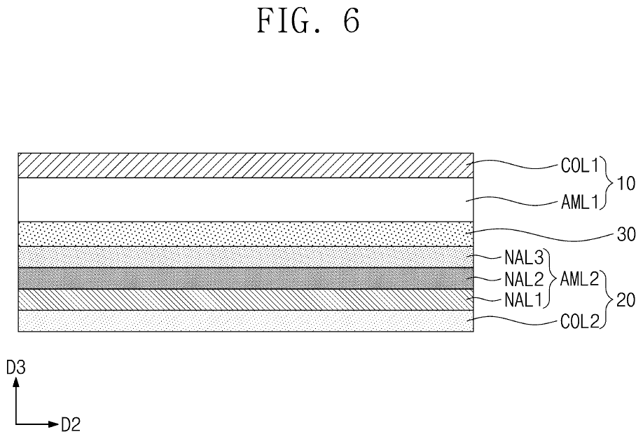

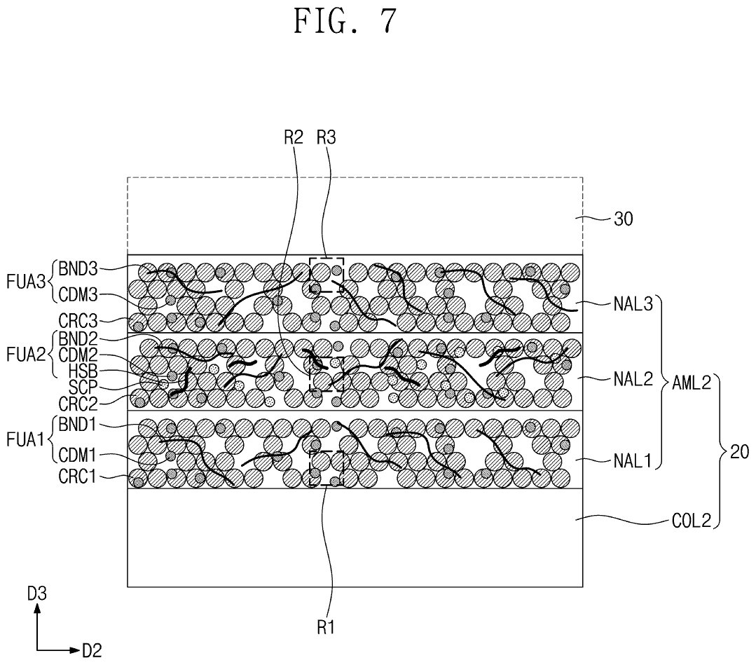

FIG. 6 illustrates a cross-sectional view showing a rechargeable lithium battery according to an example embodiment of the present disclosure. FIG. 7 illustrates an enlarged view showing a negative electrode for a rechargeable lithium battery according to an example embodiment of the present disclosure.

Referring to FIG. 6, as discussed above with reference to FIG. 1, a rechargeable lithium battery according to the present disclosure may include a positive electrode 10, a negative electrode 20, and a separator 30 between the positive electrode 10 and the negative electrode 20. Although not explicitly shown in FIG. 6, the rechargeable lithium battery according to the present disclosure may further include an electrolyte ELL. The separator 30 may be impregnated in the electrolyte ELL.

The positive electrode 10 may include a positive electrode current collector COL1 and a positive electrode active material layer AML1 on the positive electrode current collector COL1. The negative electrode 20 may include a negative electrode current collector COL2 and a negative electrode active material layer AML2 on the negative electrode current collector COL2. The separator 30 may be interposed between the positive electrode active material layer AML1 and the negative electrode active material layer AML2.

Referring to FIG. 7, the negative electrode active material layer AML2 according to an example embodiment of the present disclosure may have a multilayered structure. For example, the negative electrode active material layer AML2 may include a first active material layer NAL1, a second active material layer NAL2, and a third active material layer NAL3 that are stacked, e.g., sequentially stacked, over one another. The first active material layer NAL1 may be directly provided on the negative electrode current collector COL2. The second active material layer NAL2 may be interposed between the first active material layer NAL1 and the third active material layer NAL3.

The first to third active material layers NAL1 to NAL3 may include negative electrode active materials that are different from each other. The first to third active material layers NAL1 to NAL3 may have compositions that are different from each other. Each, or at least one, of the first to third active material layers NAL1 to NAL3 may include a carbon-based negative electrode active material, such as crystalline carbon, amorphous carbon, or any combination thereof. A detailed description thereof may be the same as the description of the negative electrode active material.

The first active material layer NAL1 may include a first crystalline carbon CRC1. The second active material layer NAL2 may include a second crystalline carbon CRC2 and a silicon-containing particle SCP. The third active material layer NAL3 may include a third crystalline carbon CRC3. Each, or at least one, of the first to third crystalline carbons CRC1 to CRC3 may be or include natural graphite, artificial graphite, or any mixture thereof.

In an example embodiment, each, or at least one, of the first active material layer NAL1 and the third active material layer NAL3 may further include a silicon-containing particle SCP, and an amount of the silicon-containing particle SCP included in each of the first and third active material layers NAL1 and NAL3 may be less than the amount of the silicon-containing particle SCP included in the second active material layer NAL2.

In an example embodiment of the present disclosure, a ratio of natural graphite among the first crystalline carbon CRC1 of the first active material layer NAL1 may be in a range of about 0 wt % to about 100 wt %, about 50 wt % to about 100 wt %, or about 80 wt % to about 100 wt %. In the first crystalline carbon CRC1 of the first active material layer NAL1, the ratio of natural graphite may be greater than the ratio of artificial graphite. In an example embodiment of the present disclosure, a ratio of artificial graphite among the third crystalline carbon CRC3 of the third active material layer NAL3 may be in a range of about 0 wt % to about 100 wt %, about 50 wt % to about 100 wt %, or about 80 wt % to about 100 wt %. In the third crystalline carbon CRC3 of the third active material layer NAL3, the ratio of artificial graphite may be greater than the ratio of natural graphite. For example, the first active material layer NAL1 may include natural graphite, the third active material layer NAL3 may include artificial graphite, and the second active material layer NAL2 may include a mixture of natural graphite and artificial graphite.

In an example embodiment of the present disclosure, the second active material layer NAL2 may further include an amorphous carbon and a silicon particle. The second active material layer NAL2 may include a silicon-carbon composite as the silicon-containing particle SCP, which will be discussed below.

The second active material layer NAL2 may include carbon (C) and silicon (Si). The silicon (Si) may be originated from the silicon-containing particle SCP. The carbon (C) may be originated from at least one of crystalline carbon, amorphous carbon, and carbon in the silicon-containing particle SCP.

A ratio of Si in the second active material layer NAL2 may be in a range of about 5 wt % to about 99 wt %, about 5 wt % to about 30 wt %, or about 5 wt % to about 10 wt %. The silicon-containing particle SCP may include at least one of silicon, silicon-carbon composite, SiOx (where 0<x<2), Si-Q alloy (where Q is alkali metal, alkaline earth metal, Group 13 element, Group 14 element (except for Si), Group 15 element, Group 16 element, transition metal, a rare-earth element, or any combination thereof), or any combination thereof.

As the second active material layer NAL2 includes the silicon-containing particle SCP, the second active material layer NAL2 may have an increased volume during charge of the rechargeable lithium battery. For example, a thickness of the second active material layer NAL2 may increase when the rechargeable lithium battery is charged. In contrast, the first active material layer NAL1 and the third active material layer NAL3 that are formed of or include only crystalline carbon may not have a large variation in volume (or thickness). This may be caused by the fact that, when the rechargeable lithium battery is charged, the silicon-containing particle SCP intercalates lithium ions more than crystalline carbon. During charge and discharge of the rechargeable lithium battery, the first active material layer NAL1 and the third active material layer NAL3 may be or include a buffer layer to reduce a variation in volume (or thickness) of the second active material layer NAL2.

Each, at least one, of the first to third active material layers NAL1 to NAL3 may further include a functional additive. For example, the first active material layer NAL1 may include a first functional additive FUA1. The second active material layer NAL2 may include a second functional additive FUA2. The third active material layer NAL3 may include a third functional additive FUA3. The first functional additive FUA1 may include a first binder BND1. The second functional additive FUA2 may include a high-strength binder HSB and a second binder BND2. The third functional additive FUA3 may include a third binder BND3.

During charge and discharge procedure, the silicon-containing particle SCP in the second active material layer NAL2 may repeatedly expand and shrink, which may cause deterioration of the second active material layer NAL2. Accordingly, the rechargeable lithium battery may have reduced lifetime characteristics. As the second active material layer NAL2 includes the high-strength binder HSB, it may be possible to reduce or prevent deterioration, and to improve lifetime characteristics of the second active material layer NAL2. Examples of the high-strength binder HSB will be discussed below.

In an example embodiment, although not shown, the first functional additive FUA1 and the third functional additive FUA3 may also include a high-strength binder HSB. However, as the first active material layer NAL1 and the third active material layer NAL3 include either no silicon-containing particle SCP or a slight amount of the silicon-containing particle SCP, there may be a relatively small effect of reducing or suppressing a volume change (shrinkage and expansion) of silicon-based active materials due to the addition of the high-strength binder HSB. Therefore, an amount of the high-strength binder HSB included in each, or at least one, of the first and third functional additives FUA1 and FUA3 may be less than the amount of the high-strength binder HSB included in the second functional additive FUA2.

Each, or at least one, of the first to third binders BND1 to BND3 may include a non-aqueous binder, an aqueous binder, a dry binder, or a combination thereof. Each, or at least one, of the non-aqueous binder, the aqueous binder, and the dry binder may be one of the binders discussed in explaining the negative electrode 20 with reference to FIG. 1.

In an example embodiment, each, or at least one, of the first to third binders BND1 to BND3 may be or include an aqueous binder that includes at least one of styrene-butadiene rubber, (meth)acrylated styrene-butadiene rubber, (meth)acrylonitrile-butadiene rubber, (meth)acrylic rubber, butyl rubber, fluororubber, polyethylene oxide, polyvinyl pyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, and a combination thereof. For example, each of the first to third binders BND1 to BND3 may be or include a rubber-based binder that includes at least one of styrene-butadiene rubber, (meth)acrylated styrene-butadiene rubber, (meth)acrylonitrile-butadiene rubber, (meth)acrylic rubber, butyl rubber, and fluororubber.

Each, or at least one, of the first to third binders BND1 to BND3 may further include a thickener capable of providing viscosity to slurry. For example, each, or at least one, of the first to third binders BND1 to BND3 may further include a cellulose-based compound discussed with reference to FIG. 1.

As the high-strength binder HSB is capable of providing viscosity to slurry, the high-strength binder HSB may replace the thickener. Thus, the second binder BND2 may include no cellulose-based compound. Alternatively, the second binder BND2 may include a cellulose-based compound, at an amount that is less than the amount of a cellulose-based compound included in each of the first and third binders BND1 and BND3.

The first functional additive FUA1 may further include a first conductive material CDM1. The second functional additive FUA2 may further include a second conductive material CDM2. The third functional additive FUA3 may further include a third conductive material CDM3.

Each, or at least one, of the first to third conductive materials CDM1 to CDM3 may be one of the conductive materials of the negative electrode 20 discussed with reference to FIG. 1. For example, each, or at least one, of the first to third conductive materials CDM1 to CDM3 may include a carbon-based material such as at least one of natural graphite, artificial graphite, carbon black, acetylene black, Ketjen black, carbon fiber, carbon nano-fiber, and carbon nano-tube; a metal powder or metal fiber containing one or more of copper, nickel, aluminum, and silver; a conductive polymer such as a polyphenylene derivative; or a mixture thereof.

In an example embodiment, in the negative electrode active material layer AML2, an amount of the first binder BND1 may be the same as the amount of the third binder BND3.

In an example embodiment, in the negative electrode active material layer AML2, an amount of the first binder BND1 may be greater than the amount of the third binder BND3. In an example embodiment, in the negative electrode active material layer AML2, an amount of the first binder BND1 may be less than the amount of the third binder BND3. A relatively large amount of binder may be distributed in the first active material layer NAL1 in contact with the negative electrode current collector COL2, and it may thus be possible to maintain an energy density, and simultaneously or contemporaneously to increase an adhesive force between a current collector and an active material layer.

In an example embodiment, the first active material layer NAL1 may include the first functional additive FUA1 in an amount of about 2 wt % to about 10 wt %. For example, the first active material layer NAL1 may include the first binder BND1 in an amount of about 2 wt % to about 5 wt %. The first binder BND1 may include an aqueous binder and a thickener. The first active material layer NAL1 may include the first conductive material CDM1 in an amount of about 0 wt % to about 5 wt %.

In an example embodiment, the second active material layer NAL2 may include the second functional additive FUA2 in an amount of about 2 wt % to about 12 wt %. For example, the second active material layer NAL2 may include the high-strength binder HSB in an amount of about 0.5 wt % to about 4 wt %. The second active material layer NAL2 may include the second binder BND2 in an amount of about 1.5 wt % to about 5 wt %. The second binder BND2 may include an aqueous binder. The second active material layer NAL2 may include the second conductive material CDM2 in an amount of about 0 wt % to about 5 wt %.

As the second active material layer NAL2 includes the high-strength binder HSB in an amount of about 0.5 wt % to about 4 wt %, a cell may increase in capacity and rapid charge rate.

In an example embodiment, the third active material layer NAL3 may include the third functional additive FUA3 in an amount of about 1 wt % to about 10 wt %. For example, the third active material layer NAL3 may include the third binder BND3 in an amount of about 1 wt % to about 5 wt %. The third binder BND3 may include an aqueous binder and a thickener. The third active material layer NAL3 may include the third conductive material CDM3 in an amount of about 0 wt % to about 5 wt %.

In an example embodiment, each, or at least one, of the first to third active material layers NAL1 to NAL3 may have a thickness of about 10 μm to about 50 μm.

In an example embodiment, the first to third active material layers NAL1 to NAL3 may have substantially the same thickness.

Alternatively, the second active material layer NAL2 may have a thickness greater than the thickness of the first active material layer NAL1. The thickness of the second active material layer NAL2 may be greater than the thickness of the third active material layer NAL3.

In an example embodiment, no distinct interfaces may be present between the first active material layer NAL1, the second active material layer NAL2, and the third active material layer NAL3. When the interfaces are not clearly distinguished, the interfaces may be determined through a concentration profile of silicon particles or a concentration profile of the high-strength binder HSB. For example, since amounts of the silicon particles and the high-strength binder HSB are abruptly increased in the second active material layer NAL2, the second active material layer NAL2 may be defined to refer to a section where concentrations of the silicon particles and the high-strength binder HSB are sharply increased and subsequently rapidly decreased again, the third active material layer NAL3 may be defined to a layer above the second active material layer NAL2, and the first active material layer NAL1 may be defined to refer to a layer below the second active material layer NAL2.

For example, the determination of the interface through the concentration profile may be carried out in the following manner. The concentration of the silicon particles or the high-strength binder HSB may be measured depending on a depth of the negative electrode active material layer AML2. There may be no particular limitation on a concentration measurement method, and for example, an optical method, an electron microscope analysis method, or an X-ray diffraction analysis method may be utilized. The concentration measurement method may measure a point where a concentration of the silicon particles or the high-strength binder HSB is abruptly increased, and may then measure a point where a concentration of the silicon particles or the high-strength binder HSB is rapidly decreased. Since amounts of the silicon particles and the high-strength binder HSB are abruptly increased in the second active material layer NAL2, the second active material layer NAL2 may be defined to refer to a region from the point where a concentration of the silicon particles or the high-strength binder HSB is abruptly increased to the point where a concentration of the silicon particles or the high-strength binder HSB is rapidly decreased. Afterwards, the first active material layer NAL1 may be defined to refer to a region (or to a layer directed toward the negative electrode current collector COL2) of the negative electrode active material layer AML2 on a bottom surface of the second active material layer NAL2, and the third active material layer NAL3 may be defined to refer to a region (or to a layer directed toward the separator 30) of the negative electrode active material layer AML2 on a top surface of the second active material layer NAL2.

For example, the “abrupt increase” in concentration may be a concentration increase of 50%, 100%, or 200% over a distance of 10 nm, and “rapid decrease” concentration may be a concentration decrease of 50%, 100%, or 200% over a distance of 10 nm.

Referring back to FIG. 7, a first region R1 may be defined to refer to a given sized space in the first active material layer NAL1. A second region R2 may be defined to refer to a given sized space in the second active material layer NAL2. A third region R3 may be defined to refer to a given sized space in the third active material layer NAL3. For example, the first region R1 may be or include a cubic space of 100 nm×100 nm×100 nm in the first active material layer NAL1, the second region R2 may be or include a cubic space of 100 nm×100 nm×100 nm in the second active material layer NAL2, and the third region R3 may be or include a cubic space of 100 nm×100 nm×100 nm in the third active material layer NAL3. A concentration of the silicon particles or the high-strength binder HSB in the first to third regions R1 to R3 may be measured to determine a concentration of the silicon particles or the high-strength binder HSB in the first to third active material layers NAL1 to NAL3, respectively.

In an example embodiment, a composition of a partial region in the first to third active material layers NAL1 to NAL3 may be analyzed without determination of the interfaces to determine a concentration of the silicon particle or the high-strength binder HSB in the first to third active material layers NAL1 to NAL3, respectively. The first to third regions R1 to R3 may be defined in the following manner.

Referring again to FIG. 7, the first region R1 may be defined to refer to a cubic space (100 nm×100 nm×100 nm) centered around a point at a given distance in a third direction D₃ from one surface of the negative electrode active material layer AML2 adjacent to the negative electrode current collector COL2. For example, the given distance may range from about 100 nm to about 200 nm.

The second region R2 may be defined to refer to a cubic space (100 nm×100 nm×100 nm) centered around a point at a given distance in the third direction D₃, or an opposite direction thereof from the center (or the middle) of a thickness in the third direction D₃ of the negative electrode active material layer AML2. For example, the given distance may be about 100 nm.

The third region R3 may be defined to refer to a cubic space (100 nm×100 nm×100 nm) centered around a point at a given distance in the third direction D₃ or an opposite direction thereof from a top surface of the negative electrode active material layer AML2 or one surface of the negative electrode active material layer AML2 adjacent to the separator 30. For example, the given distance may range from about 100 nm to about 200 nm.

In an example embodiment, the second region R2 may be interposed, e.g., vertically interposed between the first region R1 and the third region R3.

A concentration of the silicon particles or the high-strength binder HSB in the first to third regions R1 to R3 defined as discussed above may be measured to determine a concentration of the silicon particles or the high-strength binder HSB in the first to third active material layers NAL1 to NAL3, respectively.

The following description will focus on a high-strength binder.

### High-Strength Binder HSB

The high-strength binder HSB included in the second functional additive FUA2 may include a unit derived from a first monomer and a unit derived from a second monomer. The first monomer may include one or more of a (meth)allyl ether monomer and a (meth)acrylic ester monomer. For example, the (meth)ally ether monomer and the (meth)acrylic ester monomer may each have an alkyl group with three or more carbon atoms having an anionic functional group. The second monomer may be or include a (meth)acrylic monomer.

In an example embodiment, the high-strength binder HSB may be or include a copolymer of a binder monomer mixture including a first monomer and a second monomer discussed below.
i) first monomer: (meth)ally ether monomer, (meth)acrylic ester monomer, or mixture thereof
ii) second monomer: (meth)acrylic monomer

A binder formed of or including the second monomer alone may reduce or suppress a volume change (shrinkage and expansion) of a silicon-based negative electrode active material, but may increase brittleness of the negative electrode active material layer AML2. Thus, the binder may cause a crack, or cracking, during manufacturing of negative electrodes, and may increase the degree of warpage of negative electrodes. The generation of crack and warpage may become severe when a large-sized negative electrode is manufactured.

The first monomer may reduce or suppress the generation of cracking and warpage of negative electrodes without affecting an effect of reducing or suppressing shrinkage and expansion of a silicon-based negative electrode active material. For example, even when the (meth)allyl ether monomer or the (meth)acrylic ester monomer is included, there may be no trade-off relationship between an effect of reducing or suppressing a volume change of a silicon-based negative electrode active material and an effect of reducing or suppressing a crack and warpage of a negative electrode.

### First Monomer

The first monomer may include one or more of a (meth)allyl ether monomer and a (meth)acrylic ester monomer. The (meth)ally ether monomer and the (meth)acrylic ester monomer may each have an alkyl group with three or more carbon atoms substituted with an anionic functional group. The (meth)ally ether monomer and the (meth)acrylic ester monomer each of which has an alkyl group substituted with an anionic functional group may be represented by Chemical Formula 1 below.

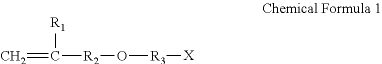

In Chemical Formula 1, R1 may be hydrogen or a methyl group.

R₂ may be or include —CH₂ or —C(═O)—.

R₃ may be or include a substituted or unsubstituted alkylene group having three or more carbon atoms, a substituted or unsubstituted amino alkylene group having three or more carbon atoms or its ammonium cation group, or a substituted or unsubstituted alkyl amino group having three or more carbon atoms or its ammonium cation group.

X may be or include an anionic functional group.

In an example embodiment, a substituent of each, or at least one, of the substituted alkylene group and the substituted amino alkylene group may be or include a hydroxyl group (—OH) or a C1 to C10 alkyl group.

In an example embodiment, the alkylene group having three or more carbon atoms may be or include a functional group represented by Chemical Formula 2 below.

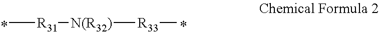

In Chemical Formula 2, the star symbol “*” may indicate a linking site of an element.

R₃₁ and R₃₃ may each independently be or include a substituted or unsubstituted C1 to C10 alkylene group.

R₃₂ may be hydrogen or a substituted or unsubstituted C1 to C10 alkyl group.

In an example embodiment, the total number of carbons of the alkylene group in each of R₃₁ and R₃₃ may be three or more.

In an example embodiment, the alkyl amino group having three or more carbon atoms may be or include a functional group represented by Chemical Formula 3 below.

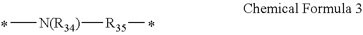

In Chemical Formula 3, the star symbol “*” may indicate a linking site of an element.

R₃₄ may be hydrogen or a substituted or unsubstituted C1 to C10 alkyl group. R₃₅ may be or include a substituted or unsubstituted alkylene group having three or more carbon atoms.

In an example embodiment, in Chemical Formula 1, R₃ may be or include a substituted or unsubstituted alkylene group having three or more carbon atoms, or a substituted or unsubstituted C3 to C10 alkylene group.

In an example embodiment, in Chemical Formula 1, R₃ may be or include a substituted or unsubstituted amino alkylene group having three or more carbon atoms or its ammonium cation group, or a substituted or unsubstituted C3 to C10 amino alkylene group or its ammonium cation group.

In Chemical Formula 1, the ammonium cation group may indicate a monovalent cationic functional group in which hydrogen or a C1 to C10 alkyl group is bonded to nitrogen of an amino group.

The anionic functional group may be or include a functional group which exhibits a monovalent or polyvalent negative charge in an aqueous solvent, and for example may include a functional group containing one or more of sulfur(S), nitrogen (N), carbon (C), phosphorus (P), and oxygen (O).

In an example embodiment, the anionic functional group may be one of a sulfonic acid group (—SO₃H), a sulfonate ion (—SO₃⁻), a phosphonic acid group (—PO(OH)₂), a phosphonate ion (—PO(OH)O⁻), a phosphate ion (—PO₃²⁻), a phosphinic acid group (—P(O)H(OH)), and a phosphinate ion (—P(O)HO⁻), or may be for example a sulfonic acid group or a sulfonate ion.

In an example embodiment, the (meth)allyl ether monomer having an alkyl group substituted with an anionic functional group may be or include a compound represented by Chemical Formula 1-1 below.

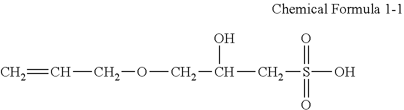

In an example embodiment, the (meth)acrylic ester monomer having an alkyl group substituted with an anionic functional group may be or include a compound represented by Chemical Formula 1-2 below or Chemical Formula 1-3 below.

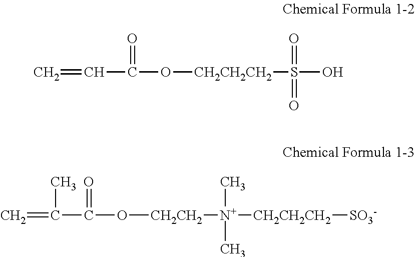

In an example embodiment, the first monomer may include one or more of compounds represented by Chemical Formulae 1-1, 1-2, and 1-3.

In an example embodiment, the binder monomer mixture used for manufacturing of the high-strength binder HSB may include the first monomer in an amount of about 3 wt % to about 15 wt %, for example, about 5 wt % to about 10 wt %. Within any of the above ranges, there may be substantially no reduction in reduction or suppression of a volume change of a silicon-based active material, and the generation of crack or warpage of a negative electrode may be reduced or suppressed to achieve coating processability.

### Second Monomer:

The second monomer may be or include a (meth)acrylic monomer. The (meth)acrylic monomer may include a (meth)acrylic group. The (meth)acrylic monomer may be substituted with a nitrile group or a carboxyl group. For example, the (meth)acrylic monomer may include one or more of (meth)acrylonitrile and (meth)acrylic acid.

In an example embodiment, the binder monomer mixture used for manufacturing of the high-strength binder HSB may include the second monomer in an amount of about 85 wt % to about 97 wt %, for example, about 90 wt % to about 95 wt %. Within any of the above ranges, a volume change of a silicon-based active material may be effectively reduced or suppressed.

For example, the binder monomer mixture may include the (meth)acrylic monomer having a nitrile group in an amount of about 30 wt % to about 50 wt %, for example, about 35 wt % to about 45 wt %. Within the range above, dispersibility of a negative electrode active material may be effectively improved.

For example, the binder monomer mixture may include the (meth)acrylic monomer having a carboxylic acid group in an amount of about 40 wt % to about 65 wt %, for example, about 50 wt % to about 60 wt %. Within any of the above ranges, a volume change of a silicon-based active material may be effectively reduced or suppressed.

### Third Monomer:

The high-strength binder HSB may further include a unit derived from a third monomer. The third monomer may be or include a (meth)acrylamide monomer having an anionic functional group. As the high-strength binder HSB further includes the third monomer, expansion of a silicon-based active material may be effectively reduced or suppressed.

In an example embodiment, the high-strength binder HSB may be or include a copolymer of the first monomer, the second monomer, and the third monomer.

The anionic functional group may be or include a functional group which exhibits a monovalent or polyvalent negative charge in an aqueous solvent, and for example may include a functional group containing one or more of sulfur(S), nitrogen (N), carbon (C), phosphorus (P), and oxygen (O).

In an example embodiment, the anionic functional group may be or include at least one of a sulfonic acid group (—SO₃H), a sulfonate ion (—SO₃⁻), a phosphonic acid group (—PO(OH)₂), a phosphonate ion (—PO(OH)O—), a phosphate ion (—PO₃²⁻), a phosphinic acid group (—P(O)H(OH)), and a phosphinate ion (—P(O)HO⁻), or may be or include for example a sulfonic acid group or a sulfonate ion.

In an example embodiment, the (meth)acrylamide monomer having an anionic functional group may be or include a compound represented by Chemical Formula 4.

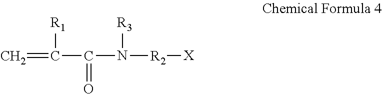

In Chemical Formula 4,
R₁ may be hydrogen or a methyl group,
R₂ may be or include a substituted or unsubstituted alkylene group having three or more carbon atoms,
R₃ may be hydrogen or a substituted or unsubstituted C1 to C10 alkyl group, and
X may be or include an anionic functional group.

For example, the third monomer may be or include 2-(meth)acrylamido-2-methyl-1-propanesulfonic acid. For example, the third monomer may be or include 2-acrylamido-2-methyl-1-propanesulfonic acid or 2-methacrylamido-2-methyl-1-propanesulfonic acid.

In an example embodiment, the binder monomer mixture used for manufacturing of the high-strength binder HSB may include the third monomer in an amount of about 1 wt % to about 5 wt %, for example, about 1 wt % to about 3 wt %. Within any of the above ranges, there may be substantially no reduction in effect of reducing or suppressing a volume change of a silicon-based active material, and the generation of crack or warpage of a negative electrode may be reduced or suppressed to achieve coating processability.

In an example embodiment, when the high-strength binder HSB includes a unit derived from the first monomer, a unit derived from the second monomer, and a unit derived from the third monomer, a ratio of the first monomer-derived unit may range from about 1 wt % to about 5 wt %, a ratio of the second monomer-derived unit may range from about 90 wt % to about 95 wt %, and a ratio of the third monomer-derived unit may range from about 1 wt % to about 5 wt %.

In an example embodiment, an average molecular weight (Mw) of the high-strength binder HSB may range from about 500,000 g/mol to about 1,500,000 g/mol, for example, from about 800,000 g/mol to about 1,000,000 g/mol. The average molecular weight may be measured as a polystyrene-equivalent value by gel permeation chromatography. Within any of the above ranges, a volume change of a silicon-based active material may be effectively reduced or suppressed.

The high-strength binder HSB may be prepared by polymerizing the first to third monomers. The polymerization may be performed by a typical method known to those skilled in the art, for example, emulsion polymerization, suspension polymerization, or solution polymerization. For example, a binder monomer mixture including the first to third monomers, an emulsifier, and an initiator may be mixed in a solvent, and heat or light may be applied to prepare the high-strength binder HSB.

In an example embodiment, the binder monomer mixture may include the first monomer and the second monomer. The binder monomer mixture may further include the third monomer.

In an example embodiment, a sum of amounts of the first and third monomers in the binder monomer mixture may range from about 3 wt % to about 15 wt %, and an amount of the second monomer in the binder monomer mixture may range from about 85 wt % to about 97 wt %. For example, a sum of amounts of the first and third monomers in the binder monomer mixture may range from about 3 wt % to about 15 wt %, and among the second monomer in the binder monomer mixture, the (meth)acrylic monomer having a nitrile group may be included in an amount of about 30 wt % to about 50 wt %, and the (meth)acrylic monomer having a carboxylic acid group may be included in an amount of about 40 wt % to about 65 wt %.

In an example embodiment, a sum of amounts of the first to third monomers in the binder monomer mixture may range from about 99.5 wt % to about 99.5 wt %. For example, the binder monomer mixture may be formed of or include the first to third monomers.

The emulsifier may be or include at least one of long-chain fatty acid alkali salt, N-acrylamino acid salt, alkyl ether carboxylic acid salt, acylated peptide, alkyl sulfonate, alkylbenzene sulfonate, alkyl amino acid salt, alkyl naphthalene sulfonate, sulfosuccinate, sulfated oil, alkyl sulfate, alkyl ether sulfate, alkyl aryl ether sulfate, alkyl amide sulfate, alkyl phosphate, alkyl ether phosphate, alkyl aryl ether phosphate, and any combination thereof. The alkyl group may be or include a C1 to C20 alkyl group. The emulsifier may be or include, for example, sodium dodecylbenzene sulfonate.

The emulsifier may be added in an amount of about 0.1 parts by weight to about 3 parts by weight or about 0.1 parts by weight to about 2 parts by weight relative to the overall 100 parts by weight of the binder monomer mixture. As the emulsifier is added within any of the above ranges, it may be possible to obtain the high-strength binder HSB having an appropriate size and adhesive force.

The initiator may be or include at least one of an azo compound initiator (e.g., azobisisobutyronitrile), ammonium persulfate, potassium persulfate, hydrogen peroxide, t-butyl hydroperoxide, and any combination thereof.

The initiator may be included in an amount of about 0.1 parts by weight to about 3 parts by weight or about 0.1 parts by weight to about 2 parts by weight relative to the total 100 parts by weight of the monomer mixture.

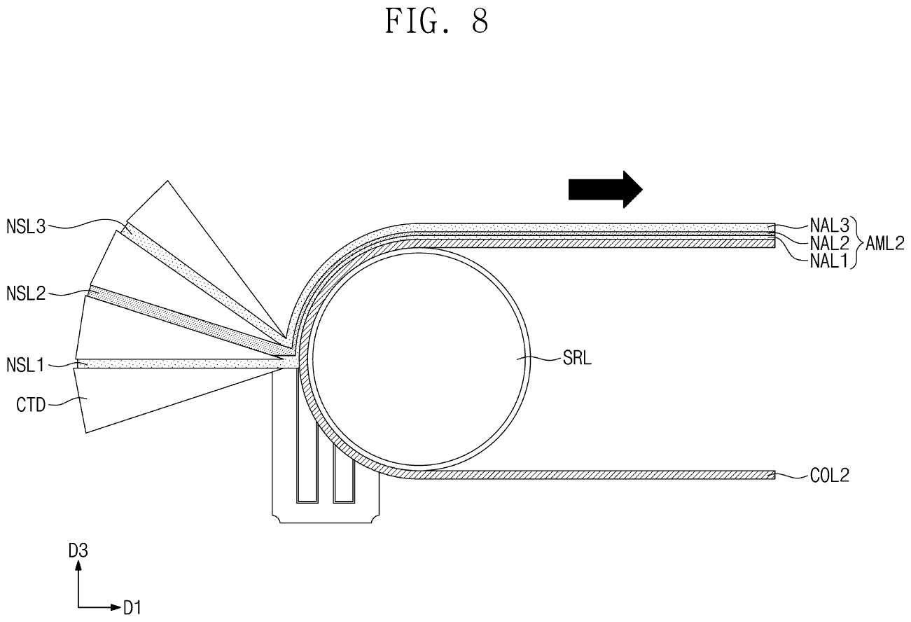

FIG. 8 illustrates a cross-sectional view showing a method of manufacturing a negative electrode according to an example embodiment of the present disclosure.

Referring to FIG. 8, a wound negative electrode current collector COL2 may be unwrapped and fed into a coating process. The traveling negative electrode current collector COL2 may be transported and coated in a first direction D1 by a supporting roll SRL. On the supporting roll SRL, the negative electrode current collector COL2 may undergo a coating process.

A coating die CTD may be disposed adjacent to the supporting roll SRL. The coating die CTD may include a plurality of slurry injection holes such as, e.g., three slurry injection holes, for slurry injection. In the example illustrated in FIG. 8, the three slurry injection holes may be respectively provided with a first negative electrode slurry NSL1, a second negative electrode slurry NSL2, and a third negative electrode slurry NSL3. When more holes are provided, more negative electrode slurries may also be provided, resulting in more active material layers.

For example, the first negative electrode slurry NSL1 may include a first crystalline carbon CRC1, a first functional additive FUA1, and a solvent. The first functional additive FUA1 may include a first binder and further include a first conductive material CDM1. The first binder BND1 may include an aqueous binder and a thickener. The second negative electrode slurry NSL2 may include a second crystalline carbon CRC2, a silicon-containing particle SCP, a second functional additive FUA2, and a solvent. The second functional additive FUA2 may include a second binder BND2 and a high-strength binder HSB. The second functional additive FUA2 may further include a second conductive material CDM2. The third negative electrode slurry NSL3 may include a third crystalline carbon CRC3, a third functional additive FUA3, and a solvent. The third functional additive FUA3 may include a third binder BND3 and further include a third conductive material CDM3. The third binder BND3 may include an aqueous binder and a thickener.

Each, or at least one, of the first to third crystalline carbons CRC1 to CRC3 may be or include natural graphite, artificial graphite, or any mixture thereof. For example, the first negative electrode slurry NSL1 may include natural graphite. The third negative electrode slurry NSL3 may include artificial graphite. Each, or at least one, of the first to third functional additives FUA1 to FUA3 may further include a conductive material.

The coating die CTD may cause the first negative electrode slurry NSL1, the second negative electrode slurry NSL2, and the third negative electrode slurry NSL3 to be coated, e.g., sequentially coated, on the negative electrode current collector COL2.

The solvent in the slurry may be or include a solvent common in the art, and for example, may include at least one of dimethyl sulfoxide (DMSO), isopropyl alcohol, N-methyl pyrrolidone (NMP), acetone, water, and any combination thereof.

The first negative electrode slurry NSL1, the second negative electrode slurry NSL2, and the third negative electrode slurry NSL3 coated on the negative electrode current collector COL2 may be dried to respectively form a first active material layer NAL1, a second active material layer NAL2, and a third active material layer NAL3 that are discussed above with reference to FIG. 6. A negative electrode active material layer AML2 may be constituted by the first active material layer NAL1, the second active material layer NAL2, and the third active material layer NAL3 that are stacked, e.g., sequentially stacked on the negative electrode current collector COL2.

Afterwards, the negative electrode 20 may undergo, e.g., sequentially undergo, a roll pressing process, a slitting process, and a notching process. The negative electrode 20, a separator 30, and a positive electrode 10 may be stacked, and an electrolyte ELL may be subsequently provided to fabricate a rechargeable lithium battery according to the present disclosure.

The following description will focus on some example embodiments of the present disclosure. The following example embodiments are provided to aid in understanding of the present disclosure and are not intended to limit the scope of the present disclosure.

### Preparation Example

### Preparation of Silicon-Carbon Composite

Crystalline carbon (e.g., graphite, GNs, soft carbon), nano-Si (D₅₀: 100 nm) ground fop 10 to 20 hours by using a Beads Mill (commercially available from NETZSCH), amorphous carbon (pitch, resin, hydrocarbon, and the like) were mixed in a weight ratio of 40:40:20, and a homogenizer was subsequently used to uniformly disperse the mixture in a solvent (e.g., IPA, ETOH, and the like). The dispersed mixture was spray-dried at a temperature of 50° C. to 100° C. with a spray dryer, and thermally treated at a temperature of 900° C. to 1,000° C. in an N₂ furnace to coat amorphous carbon. Subsequently, crushing and sieving with a 400 mesh were used to eventually obtain a silicon-carbon composite with an amorphous carbon coating layer.

### High-Strength Binder

A high-strength binder was prepared as follows, and the characteristics of the high-strength binder were evaluated.

### Preparation 1

Based on the total 100 wt %, 55 wt % of acrylic acid (AA), 40 wt % of acrylonitrile (AN), and 5 wt % of 2-allyloxy-2-hydroxy-1-propanesulfonic acid (AHPS) were mixed to prepare a binder monomer mixture. An azo compound initiator and water were added to 100 parts by weight of the binder monomer mixture. The initiator was included in an amount of 0.2 parts by weight relative to 100 parts by weight of the binder monomer mixture.

Subsequently, the mixture was subjected to emulsion polymerization to prepare an aqueous binder solution that includes a copolymer (average molecular weight: 910,000 g/mol) having a unit derived from acrylic acid (AA), a unit derived from acrylonitrile (AN), and a unit derived from 2-allyloxy-2-hydroxy-1-propanesulfonic acid (AHPS). For example, an aqueous binder solution was prepared which includes a high-strength binder (average molecular weight: 910,000 g/mol) according to the present disclosure.

### Preparation 2

An aqueous binder solution including a high-strength binder (average molecular weight: 910,000 g/mol) was prepared in the same method as in Preparation 1, with a difference that, based on the total 100 wt %, 55 wt % of acrylic acid (AA), 40 wt % of acrylonitrile (AN), and 5 wt % of 3-sulfopropyl acrylate (SPA) were mixed to prepare a binder monomer mixture.

### Preparation 3

An aqueous binder solution including a high-strength binder (average molecular weight: 870,000 g/mol) was prepared in the same method as in Preparation 1, with a difference that, based on the total 100 wt %, 55 wt % of acrylic acid (AA), 40 wt % of acrylonitrile (AN), and 5 wt % of [2-(methacryloyloxy)ethyl]dimethyl-(3-sulfopropyl)ammonium hydroxide (MSAH) were mixed to prepare a binder monomer mixture.

### Preparation 4

An aqueous binder solution including a high-strength binder (average molecular weight: 870,000 g/mol) was prepared in the same method as in Preparation 1, with a difference that, based on the total 100 wt %, 55 wt % of acrylic acid (AA), 40 wt % of acrylonitrile (AN), 2.5 wt % of 2-allyloxy-2-hydroxy-1-propanesulfonic acid (AHPS), and 2.5 wt % of 2-acrylamido-2-methyl-1-propanesulfonic acid (AMPS) were mixed to prepare a binder monomer mixture.

### Preparation 5

An aqueous binder solution including a high-strength binder (average molecular weight: 910,000 g/mol) was prepared in the same method as in Preparation 1, with a difference that, based on the total 100 wt %, 50 wt % of acrylic acid (AA), 40 wt % of acrylonitrile (AN), and 10 wt % of 2-allyloxy-2-hydroxy-1-propanesulfonic acid (AHPS) were mixed to prepare a binder monomer mixture.

### Preparation 6

An aqueous binder solution including a high-strength binder (average molecular weight: 910,000 g/mol) was prepared in the same method as in Preparation 1, with a difference that, based on the total 100 wt %, 56 wt % of acrylic acid (AA), 40 wt % of acrylonitrile (AN), and 4 wt % of 2-allyloxy-2-hydroxy-1-propanesulfonic acid (AHPS) were mixed to prepare a binder monomer mixture.

### Preparation 7

An aqueous binder solution including a high-strength binder (average molecular weight: 910,000 g/mol) was prepared in the same method as in Preparation 1, with a difference that, based on the total 100 wt %, 49 wt % of acrylic acid (AA), 40 wt % of acrylonitrile (AN), and 11 wt % of 2-allyloxy-2-hydroxy-1-propanesulfonic acid (AHPS) were mixed to prepare a binder monomer mixture.

### Comparative Preparation 1

An aqueous binder solution including a binder (average molecular weight: 900,000 g/mol) was prepared in the same method as in Preparation 1, with a difference that, based on the total 100 wt %, 60 wt % of acrylic acid (AA) and 40 wt % of acrylonitrile (AN) were mixed to prepare a binder monomer mixture.

### Comparative Preparation 2

An aqueous binder solution including a binder (average molecular weight: 890,000 g/mol) was prepared in the same method as in Preparation 1, with a difference that, based on the total 100 wt %, 55 wt % of acrylic acid (AA), 40 wt % of acrylonitrile (AN), and 5 wt % of vinylsulfonic acid (VS) were mixed to prepare a binder monomer mixture.

### Comparative Preparation 3

An aqueous binder solution including a binder (average molecular weight: 880,000 g/mol) was prepared in the same method as in Preparation 1, with a difference that, based on the total 100 wt %, 55 wt % of acrylic acid (AA), 40 wt % of acrylonitrile (AN), and 5 wt % of styrene (St) were mixed to prepare a binder monomer mixture.

### Fabrication of Rechargeable Lithium Battery for Evaluation of Binder

The binder solutions of Preparations 1 to 7 and Comparative Preparations 1 to 3 were used to fabricate a rechargeable lithium battery and to evaluate characteristics of the rechargeable lithium battery. For example, one of the binder solutions of Preparations 1 to 7 and Comparative Preparations 1 to 3, styrene-butadiene rubber, and a negative electrode active material were mixed with water to prepare a negative electrode active material slurry. Based on a solid substance excluding water, the negative electrode active material slurry was prepared to include 1.5 wt % of the aqueous binder, 2.0 wt % of styrene-butadiene rubber, 0.5 wt % of carbon nano-tube as a conductive material, and 0.96 wt % of a negative electrode active material. The negative electrode active material was a mixed active material containing an artificial/natural graphite mixture and a silicon-carbon composite mixed in a weight ratio of 90:10. The silicon-carbon composite included an aggregate of second particles composed of artificial graphite and silicon nano-particles, and had a soft-carbon layer formed on a surface of the aggregate. Based on the total weight of the silicon-carbon composite, an amount of the artificial graphite was 40 wt %, an amount of the silicon nano-particles was 40 wt %, and an amount of the soft carbon was 20 wt %.

The negative electrode active material slurry was coated on a current collector formed of or including copper foil, and dried and pressed to manufacture a negative electrode.

The manufactured negative electrode, the positive electrode, and the electrolyte were used to perform an ordinary method to fabricate a full-cell battery. The electrolyte was prepared by dissolving 1.5.0M LiPF₆ in a solvent containing ethylene carbonate, ethylmethyl carbonate, and dimethyl carbonate mixed in a volume ratio of 30:50:20. The positive electrode was manufactured in such a way that 96 wt % of LiCoO₂, 2 wt % of Ketjen black, and 2 wt % of polyvinylidene fluoride were mixed in a solvent of N-methyl pyrrolidone to prepare a positive electrode active material, and that the positive electrode slurry was coated, dried, and pressed on an aluminum current collector.

### Evaluation of Binder

1) Crack Generation: there was visually evaluated a crack generated during processes in which the binder solutions of Preparations 1 to 7 and Comparative Preparations 1 to 3 were applied and negative electrode slurries were coated. For example, a surface of the negative electrode was visually observed to determine whether a crack is generated.

2) Warpage: the negative electrode, to which one of the binder solutions of Preparations 1 to 7 and Comparative Preparations 1 to 3 was applied, was cut into a sample having a size of 5 cm×5 cm (width×length), and when the sample was left for 1 hour in a dry room and placed on a flat surface, a maximum height of the negative electrode was estimated.

3) Expansion Rate of Negative Electrode on Full Charge: the rechargeable lithium battery, to which one of the binder solutions of Preparations 1 to 7 and Comparative Preparations 1 to 3 was applied, was charged at 0.2 C rate and 25° C. under the condition of constant current until a voltage reached 4.2 V, and then cut-off at 0.025 C rate under the condition of constant voltage. An expansion rate of the negative electrode was determined by calculating a ratio of thickness of the negative electrode after the procedure to the thickness of the negative electrode before the procedure.

4) Lifetime: a stack full cell was manufactured by stacking 10 rechargeable lithium batteries to which one of the binder solutions of Preparations 1 to 7 and Comparative Preparations 1 to 3 is applied, and the stack full cell was charged at 0.33 C and 25° C. to estimate a cycle count at which a capacity retention rate reached 90%.

Table 1 lists the evaluation result.

TABLE 1

| | | Kind | | Warpage | Expansion | |
|---|---|---|---|---|---|---|
| | Inclusion of | (amount) of | Crack | of | rate of | |
| | anionic | first and | generation | negative | negative | |
| | functional | third | of negative | electrode | electrode | |
| | group | monomers | electrode | (cm) | (%) | SOH90 |
| Preparation 1 | ◯ | AHPS | Never | 0.9 | 30.5 | 500 |
| | | (5 wt %) | occurred | | | |
| Preparation 2 | ◯ | SPA | Never | 0.9 | 30.4 | 510 |
| | | (5 wt %) | occurred | | | |
| Preparation 3 | ◯ | MSAH | Never | 1.2 | 31 | 510 |
| | | (5 wt %) | occurred | | | |
| Preparation 4 | ◯ | AHPS + | Never | 1.1 | 30 | 525 |
| | | AMPS | occurred | | | |
| | | (2.5 wt % + | | | | |
| | | 2.5 wt %) | | | | |
| Preparation 5 | ◯ | AHPS | Never | 1.0 | 30 | 500 |
| | | (10 wt %) | occurred | | | |
| Preparation 6 | ◯ | AHPS | Slightly | 1.3 | 30 | 500 |
| | | (4 wt %) | occurred | | | |
| Preparation 7 | ◯ | AHPS | Never | 1.0 | 31.5 | 500 |
| | | (11 wt %) | occurred | | | |
| Comparative | X | — | Largely | 5 | 30 | 10 |
| Preparation 1 | | | occurred | | | |
| Comparative | ◯ | — | Largely | 5.1 | 32 | 10 |
| Preparation 2 | | | occurred | | | |
| Comparative | X | — | Largely | 4.9 | 31 | 10 |
| Preparation 3 | | | occurred | | | |

As shown in Table 1, the binders of Preparations 1 to 7 improved lifetime characteristics by causing a reduction in volume change of the silicon-based negative electrode active material and an improvement in brittleness of the negative electrode. Therefore, it may be confirmed that the binders of Preparation Examples 1 to 7 was estimated to be suitable for use as a high-strength binder, and the high-strength binder of Preparation 1 was used in other example embodiments.

### Example Embodiment 1

### Manufacture of Negative Electrode

98 wt % of natural graphite, 0.8 wt % of carboxymethyl cellulose, and 1.2 wt % of styrene-butadiene rubber were mixed in pure water to prepare a first negative electrode slurry.

44 wt % of natural graphite, 44 wt % of artificial graphite, 9 wt % of a silicon-carbon composite, 0.8 wt % of the high-strength binder of Preparation 1, and 2.2 wt % of styrene-butadiene rubber were mixed in pure water to prepare a second negative electrode slurry.

98 wt % of artificial graphite, 0.8 wt % of carboxymethyl cellulose, and 1.2 wt % of styrene-butadiene rubber were mixed in pure water to prepare a third negative electrode slurry.

The first negative electrode slurry, the second negative electrode slurry, and the third negative electrode slurry were coated, e.g., sequentially coated, on a copper current collector. Thereafter, the obtained product was dried at 80° C. and then pressed to manufacture a negative electrode in which first to third active material layers were stacked, e.g., sequentially stacked, on the copper current collector.

### Fabrication of Half Cell

The manufactured negative electrode was wound into a circular shape with a diameter of 14 mm, and a 2032-type coin half-cell was fabricated with lithium metal as a counter electrode. An organic electrolyte was used in which 1.3M LiPF₆ was dissolved in a mixed solvent containing ethylene carbonate, diethyl carbonate, and fluoroethylene carbonate mixed in a weight ratio of 2:6:2.

### Fabrication of Full Cell

96 grams of LiNi_{0.6}Co_{0.2}Mn_{0.2}O₂ as a positive electrode active material, 2 grams of polyvinylidene fluoride, 47 grams of N-methyl pyrrolidone as a solvent, and 2 grams of carbon black as a conductive material were mixed to prepare a positive electrode slurry. A doctor blade was used to coat the positive electrode slurry on an aluminum current collector to manufacture a positive electrode. The positive electrode was dried at 135° C. for 3 hours or more, and subsequently pressed and vacuum dried.

The manufactured negative electrode, a polytetrafluoroethylene (PTFE) separator, and the positive electrode were stacked to fabricate a rechargeable lithium battery. 1.3M LiPF₆, dissolved in a mixed solvent containing ethylene carbonate (EC), ethylmethyl carbonate (EMC), and diethyl carbonate (DEC) mixed in a volume ratio of 3:5:2, was used as an electrolyte to fabricate a CR2032-type coin full-cell.

### Example Embodiment 2

A negative electrode, a half-cell, and a coin full-cell were fabricated in the same method as in Example Embodiment 1, with a difference that 43.65 wt % of natural graphite, 43.65 wt % of artificial graphite, 9 wt % of a silicon-carbon composite, 1.5 wt % of a high-strength binder, and 2.2 wt % of styrene-butadiene rubber were mixed in pure water to prepare a second negative electrode slurry.

### Example Embodiment 3

A negative electrode, a half-cell, and a coin full-cell were fabricated in the same method as in Example Embodiment 1, with a difference that 44.15 wt % of natural graphite, 44.15 wt % of artificial graphite, 9 wt % of a silicon-carbon composite, 0.5 wt % of a high-strength binder, and 2.2 wt % of styrene-butadiene rubber were mixed in pure water to prepare a second negative electrode slurry.

### Example Embodiment 4

A negative electrode, a half-cell, and a coin full-cell were fabricated in the same method as in Example Embodiment 1, with a difference that 42.4 wt % of natural graphite, 42.4 wt % of artificial graphite, 9 wt % of a silicon-carbon composite, 4 wt % of a high-strength binder, and 2.2 wt % of styrene-butadiene rubber were mixed in pure water to prepare a second negative electrode slurry.

### Comparative Example 1

A negative electrode, a half-cell, and a coin full-cell were fabricated in the same method as in Example Embodiment 1, with a difference that carboxymethyl cellulose was used to replace a high-strength binder when a second negative electrode slurry was prepared.

For example, 44 wt % of natural graphite, 44 wt % of artificial graphite, 9 wt % of a silicon-carbon composite, 0.8 wt % of carboxymethyl cellulose, and 2.2 wt % of styrene-butadiene rubber were mixed in pure water to prepare a second negative electrode slurry.

### Comparative Example 2

A negative electrode, a half-cell, and a coin full-cell were fabricated in the same method as in Example Embodiment 1, with a difference that 44.2 wt % of natural graphite, 44.2 wt % of artificial graphite, 9 wt % of a silicon-carbon composite, 0.4 wt % of a high-strength binder, and 2.2 wt % of styrene-butadiene rubber were mixed in pure water to prepare a second negative electrode slurry.

### Comparative Example 3

A negative electrode, a half-cell, and a coin full-cell were fabricated in the same method as in Example Embodiment 1, with a difference that 42.15 wt % of natural graphite, 42.15 wt % of artificial graphite, 9 wt % of a silicon-carbon composite, 4.5 wt % of a high-strength binder, and 2.2 wt % of styrene-butadiene rubber were mixed in pure water to prepare a second negative electrode slurry.

### Comparative Example 4

A negative electrode, a half-cell, and a coin full-cell were fabricated in the same method as in Example Embodiment 1, with a difference that 41.9 wt % of natural graphite, 41.9 wt % of artificial graphite, 9 wt % of a silicon-carbon composite, 5 wt % of a high-strength binder, and 2.2 wt % of styrene-butadiene rubber were mixed in pure water to prepare a second negative electrode slurry.

### Comparative Example 5

A negative electrode, a half-cell, and a coin full-cell were fabricated in the same method as in Example Embodiment 1, with a difference that a high-strength binder was used to replace carboxymethyl cellulose when a first negative electrode slurry was prepared, and that carboxymethyl cellulose was used to replace a high-strength binder when a second negative electrode slurry was prepared.

For example, 98 wt % of natural graphite, 0.8 wt % of the high-strength binder of Preparation 1, and 1.2 wt % of styrene-butadiene rubber were mixed in pure water to prepare a first negative electrode slurry.

44 wt % of natural graphite, 44 wt % of artificial graphite, 9 wt % of a silicon-carbon composite, 0.8 wt % of carboxymethyl cellulose, and 2.2 wt % of styrene-butadiene rubber were mixed in pure water to prepare a second negative electrode slurry.

For example, a negative electrode, a half-cell, and a coin full-cell were fabricated such that a high-strength binder was included in the first active material layer but not in the second active material layer.

Table 2 lists an amount of the high-strength binder used when the second negative electrode slurry was prepared.

TABLE 2

| | High-strength binder |
|---|---|
| Category | (wt %) |
| Example | 0.8 |
| Embodiment 1 | |
| Example | 1.5 |
| Embodiment 2 | |
| Example | 0.5 |
| Embodiment 3 | |
| Example | 4 |
| Embodiment 4 | |
| Comparative | —(0.8% of carboxyl |
| Example 1 | cellulose) |
| Comparative | 0.4 |
| Example 2 | |
| Comparative | 4.5 |
| Example 3 | |
| Comparative | 5 |
| Example 4 | |
| Comparative | —(0.8% of carboxyl |
| Example 5 | cellulose) |

### Evaluation 1: Crack Generation

There was visually evaluated a crack generated during processes for coating the negative electrode slurries of Example Embodiments 1 to 4 and Comparative Examples 1 to 5. For example, a surface of the negative electrode was visually observed to determine whether a crack is generated.

TABLE 3

| | Crack generation of negative |
|---|---|
| Category | electrode |
| Example | Never occurred |
| Embodiment 1 | |
| Example | Never occurred |
| Embodiment 2 | |
| Example | Never occurred |
| Embodiment 3 | |
| Example | Never occurred |
| Embodiment 4 | |
| Comparative | Never occurred |
| Example 1 | |
| Comparative | Never occurred |
| Example 2 | |
| Comparative | Slightly occurred |
| Example 3 | |
| Comparative | Slightly occurred |
| Example 4 | |
| Comparative | Slightly occurred |
| Example 5 | |

Referring to Table 3, a crack was generated in the negative electrode when an amount of the high-strength binder was greater than 4 wt %, or when the high-strength binder was added to the first active material layer instead of the second active material layer.

### Evaluation 2: Thickness Change Rate of Rechargeable Lithium Battery

A thickness change rate at a high temperature (45° C.) was measured for the coin full-cells using the negative electrodes of Example Embodiment 1 and Comparative Example 1. A charge at 2.0 C and 4.4 V cut-off under a constant current, a charge at 0.05 C cut-off under a constant voltage, and then a discharge at 1.0 C and 3.0 V under a constant current, were set to be one cycle, and the one cycle was repeated 300 times. A thickness change rate was measured after 100 cycles, 200 cycles, and 300 cycles of charge-discharge compared to an initial charge-discharge. A vernier caliper was used to measure a thickness change rate (increase rate) at SOC 100% after the cycle charge-discharge was performed, and the result is listed in Table 4.

TABLE 4

| | Thickness change rate (%) | | | |
|---|---|---|---|---|
| Category | 0 cycle | 100 cycles | 200 cycles | 300 cycles |
| Example Embodiment | 0.0 | 3.5 | 6.0 | 7.5 |
| 1 | | | | |
| Example Embodiment | 0.0 | 3.3 | 5.8 | 7.1 |
| 2 | | | | |
| Example Embodiment | 0.0 | 3.8 | 6.5 | 8.0 |
| 3 | | | | |
| Example Embodiment | 0.0 | 3.0 | 5.1 | 6.0 |
| 4 | | | | |
| Comparative Example | 0.0 | 4.5 | 8.0 | 10.0 |
| 1 | | | | |
| Comparative Example | 0.0 | 4.0 | 6.8 | 8.3 |
| 2 | | | | |
| Comparative Example | 0.0 | 2.7 | 4.9 | 5.8 |
| 3 | | | | |
| Comparative Example | 0.0 | 2.6 | 4.7 | 5.6 |
| 4 | | | | |
| Comparative Example | 0.0 | 4.7 | 8.5 | 11.5 |
| 5 | | | | |

Referring to Table 4, the rechargeable lithium batteries of Example Embodiments 1 to 4 had thickness change rates that are less than the thickness change rates of the rechargeable lithium batteries of Comparative Examples 1 and 5. For example, since the negative electrode according to the present disclosure included a given amount of the high-strength binder, a variation in thickness of the rechargeable lithium battery was reduced or prevented to improve stability of the rechargeable lithium battery.

### Evaluation 3: Lifetime Characteristics

The rechargeable lithium batteries fabricated according to Example Embodiments 1 to 4 and Comparative Examples 1 to 5 were subjected to a charge-discharge experiment using an electrochemical analyzer (Toyo, Toscat-3100) at a temperature of 25° C. in a voltage range of 3.0 V to 4.3 V under a discharge rate of 0.2 C to 5.0 C, thereby measuring an initial charge capacity and an initial discharge capacity. Thereafter, the rechargeable lithium battery was subjected to 200 cycles of charge-discharge at a temperature of 25° C. in a driving voltage range of 3.0 V to 4.4 V under a condition of 1 C/1 C, and then a ratio of a discharge capacity at 200th cycle to an initial capacity (or a capacity retention) was measured and the measured value was defined as lifetime characteristics (%). The result is listed in Table 5.

TABLE 5

| | | Initial | |
|---|---|---|---|
| | Initial charge | discharge | Lifetime |
| | capacity | capacity | characteristics at |
| Category | (mAh/g) | (mAh/g) | 200^{th} cycle (%) |
| Example | 210.1 | 199.5 | 96.4 |
| Embodiment 1 | | | |
| Example | 209.4 | 198.9 | 97 |
| Embodiment 2 | | | |
| Example | 210.7 | 200.1 | 95.2 |
| Embodiment 3 | | | |
| Example | 208.9 | 198.5 | 97.4 |
| Embodiment 4 | | | |
| Comparative | 211.1 | 200.5 | 90.2 |
| Example 1 | | | |
| Comparative | 210.9 | 200.3 | 92 |
| Example 2 | | | |
| Comparative | 208.3 | 198.0 | 93.5 |
| Example 3 | | | |
| Comparative | 207.9 | 197.5 | 90.8 |
| Example 4 | | | |
| Comparative | 210.8 | 200.2 | 90.4 |
| Example 5 | | | |

Referring to Table 5, the negative electrode of Comparative Example 1, which includes no high-strength binder, exhibits poor lifetime characteristics. In addition, the negative electrode of Comparative Example 5, which includes the high-strength binder in the first active material layer instead of the second active material layer, exhibits poor lifetime characteristics.

In addition, the negative electrode of Comparative Example 2 exhibits poor lifetime characteristics, and it appears that a low amount of the high-strength binder fails to effectively reduce or suppress a change in volume of the silicon-based active material.

Moreover, the negative electrodes of Comparative Examples 3 and 4 exhibit poor lifetime characteristics, and it may be believed that, in consideration of crack generation, the crack causes a deterioration of lifetime characteristics.

In contrast, each of the negative electrodes of Example Embodiments 1 to 4, in which the second electrode slurry includes the high-strength binder in an amount of 0.5 wt % to 4 wt %, exhibits desired or improved lifetime characteristics (or a ratio of the discharge capacity at 200th cycle to the initial capacity) of equal to or greater than 95%.

In a negative electrode for a rechargeable lithium battery according to the present disclosure, a silicon-containing active material layer may be disposed between silicon-free active material layers to thereby mitigate a volume change of the silicon-containing active material layer. Further, a high-strength binder may be disposed in the silicon-containing active material layer to effectively reduce or suppress a change in volume of the silicon-based active material and accordingly to reduce or suppress expansion caused by degradation of a rechargeable lithium battery. In conclusion, a rechargeable lithium battery according to the present disclosure may have superior lifetime characteristics.

While this disclosure has been described in connection with what is presently considered to be preferred example embodiments, it is to be understood that the present disclosure is not limited to the disclosed example embodiments and is intended to cover various modifications and equivalent arrangements included within the spirit and scope of the appended claims, and therefore the aforementioned example embodiments should be understood to be exemplarily but not limiting this disclosure in any way.

What is claimed is:

1. A negative electrode for a rechargeable lithium battery, the negative electrode comprising:
a negative electrode current collector; and
a negative electrode active material layer on the negative electrode current collector,
wherein the negative electrode active material layer includes a first active material layer, a second active material layer, and a third active material layer that are stacked on the negative electrode current collector,
wherein the second active material layer includes a silicon-containing particle and a high-strength binder,
wherein the high-strength binder includes:
a unit derived from a first monomer; and
a unit derived from a second monomer,
wherein the first monomer includes one or more of a (meth)allyl ether monomer and a (meth)acrylic ester monomer, and
wherein the second monomer comprises a (meth)acrylic monomer.

2. The negative electrode of claim 1, wherein at least one of the (meth)ally ether monomer and the (meth)acrylic ester monomer has an alkyl group with three or more carbon atoms substituted with an anionic functional group.

3. The negative electrode of claim 2, wherein the anionic functional group comprises at least one of a sulfonic acid group (—SO₃H), a sulfonate ion (—SO₃⁻), a phosphonic acid group (—PO(OH)₂), a phosphonate ion (—PO(OH)O⁻), a phosphate ion (—PO₃²⁻), a phosphinic acid group (—P(O)H(OH)), and a phosphinate ion (—P(O)HO⁻).

4. The negative electrode of claim 1, wherein the first monomer comprises a compound represented by Chemical Formula 1, 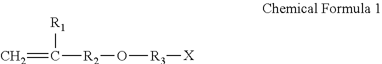
wherein, in Chemical Formula 1,
R₁ comprises one of hydrogen and a methyl group,
R₂ comprises one of —CH₂ and —C(═O)—,
R₃ comprises at least one of a substituted or unsubstituted alkylene group having three or more carbon atoms, a substituted or unsubstituted amino alkylene group having three or more carbon atoms or an ammonium cation group thereof, and a substituted or unsubstituted alkyl amino group having three or more carbon atoms or an ammonium cation group thereof, and
X comprises an anionic functional group.

5. The negative electrode of claim 1, wherein the (meth)acrylic monomer comprises one or more of a (meth)acrylic monomer having a nitrile group and a (meth)acrylic monomer having a carboxylic acid group.

6. The negative electrode of claim 1, wherein the high-strength binder further comprises a unit derived from a third monomer,
wherein the third monomer comprises a (meth)acrylic amide monomer having an anionic functional group.

7. The negative electrode of claim 6, wherein the third monomer comprises a compound represented by Chemical Formula 4, 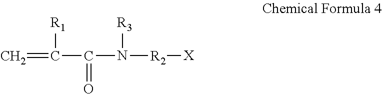
wherein, in Chemical Formula 4,
R₁ comprises one of hydrogen and a methyl group,
R₂ comprises a substituted or unsubstituted alkylene group having three or more carbon atoms,
R₃ comprises one of hydrogen and a substituted or unsubstituted C1 to C10 alkyl group, and
X comprises an anionic functional group.

8. The negative electrode of claim 6, wherein, in the high-strength binder,
a ratio of the unit derived from the first monomer is in a range of about 1 wt % to about 5 wt %,
a ratio of the unit derived from the second monomer is in a range of about 90 wt % to about 95 wt %, and
a ratio of the unit derived from the third monomer is in a range of about 1 wt % to about 5 wt %.

9. The negative electrode of claim 1, wherein an average molecular weight of the high-strength binder is in a range of about 500,000 g/mol to about 1,500,000 g/mol.

10. The negative electrode of claim 1, wherein the second active material layer comprises the high-strength binder in an amount of about 0.5 wt % to about 4 wt %.

11. The negative electrode of claim 1, wherein at least one of the first, second, and third active material layers has a thickness of about 10 μm to about 50 μm.

12. The negative electrode of claim 1, wherein the silicon-containing particle comprises at least one of silicon, a silicon-carbon composite, silicon oxide, and a Si-Q alloy,
wherein Q comprises at least one of alkali metal, alkaline earth metal, a Group 13 element, a Group 14 element except for Si, a Group 15 element, a Group 16 element, transition metal, and a rare-earth element.

13. A negative electrode for a rechargeable lithium battery, the negative electrode comprising:
a negative electrode current collector; and
a negative electrode active material layer on the negative electrode current collector,
wherein the negative electrode active material layer includes crystalline carbon, a silicon-containing particle, and a high-strength binder,
wherein the negative electrode active material layer has:
a first region adjacent to the negative electrode current collector;
a third region adjacent to a top surface of the negative electrode active material layer; and
a second region on a center of the negative electrode active material layer,
wherein the second region is interposed between the first region and the third region,
wherein an amount of the silicon-containing particle in the second region is greater than an amount of the silicon-containing particle in the first region,
wherein the amount of the silicon-containing particle in the second region is greater than an amount of the silicon-containing particle in the third region,
wherein an amount of the high-strength binder in the second region is greater than an amount of the high-strength binder in the first region, and
wherein the amount of the high-strength binder in the second region is greater than an amount of the high-strength binder in the third region.

14. The negative electrode of claim 13, wherein:
the first region includes a first binder,
the third region includes a third binder, and
at least one of the first binder and the third binder includes an aqueous binder and a thickener, the aqueous binder including at least one of styrene-butadiene rubber, (meth)acrylated styrene-butadiene rubber, (meth)acrylonitrile-butadiene rubber, (meth)acrylic rubber, butyl rubber, fluororubber, polyethylene oxide, polyvinyl pyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenolic resin, and epoxy resin.

15. The negative electrode of claim 14, wherein the thickener comprises a cellulose-based compound.

16. The negative electrode of claim 13, wherein the second region comprises a second binder,
wherein the second binder comprises an aqueous binder including at least one of styrene-butadiene rubber, (meth)acrylated styrene-butadiene rubber, (meth)acrylonitrile-butadiene rubber, (meth)acrylic rubber, butyl rubber, fluoro elastomer, polyethylene oxide, polyvinyl pyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, and polyvinyl alcohol.

17. The negative electrode of claim 13, wherein the high-strength binder comprises:
a unit derived from a first monomer; and
a unit derived from a second monomer,
wherein the first monomer comprises one or more of a (meth)allyl ether monomer and a (meth)acrylic ester monomer, and
wherein the second monomer comprises a (meth)acrylic monomer.

18. The negative electrode of claim 13, wherein the second region comprises the high-strength binder in an amount of about 0.5 wt % to about 4 wt %.

19. The negative electrode of claim 13, wherein at least one of the first, second, and third active material layers has a thickness of about 10 μm to about 50 μm.

20. A rechargeable lithium battery, comprising:
the negative electrode as set forth in claim 1;
a positive electrode that includes a positive electrode current collector and a positive electrode active material layer on the positive electrode current collector; and
a separator between the negative electrode and the positive electrode.
